(19) United States
(12) Patent Application Publication
(10) Pub. No.: US 2012/0321235 A1
(43) Pub. Date: Dec. 20, 2012

(54) ROLLING BEARING SEAL WITH AN ELASTOMER-BASED PRESEAL

(75) Inventor: Kleberson SIERRA, SOROCABA (BR)

(73) Assignee: SCHAEFFLER TECHNOLOGIES AG & CO. KG, Herzogenaurach (DE)

(21) Appl. No.: 13/486,245

(22) Filed: Jun. 1, 2012

(30) Foreign Application Priority Data
Jun. 17, 2011 (DE) 10 2011 077 729.6

(51) Int. Cl. F16C 33/78; F16C 19/00; F16C 33/34

(52) U.S. Cl. 384/484; 277/549

(57) ABSTRACT

A seal arrangement, in particular a cartridge seal, which has a carrier ring that is fastenable to a first bearing ring and a cover ring that is movable in relation to the carrier ring and fastenable to a second bearing ring. The carrier ring carries an elastic part which forms at least one sealing lip that makes sliding sealing contact with the cover ring. The elastic part forms an overhang arranged axially on a radially running portion of the carrier ring, and the overhang radially covers a radial end piece of the cover ring at least partially. The overhang consequently assumes the sealing function of the carrier ring so that the carrier ring can form a sealing gap with the cover ring. The elastic part has to be attached on only one axial side of the carrier ring and thus the fastening region of the carrier ring can be made smaller.

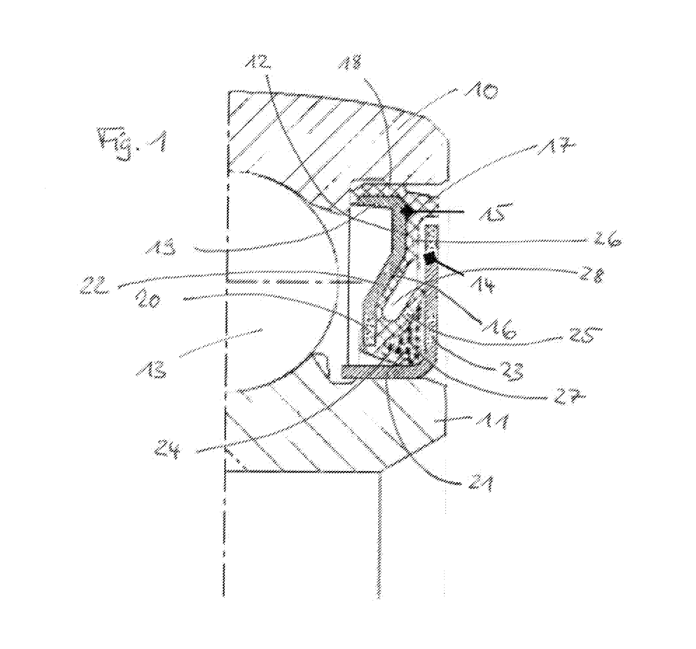

### CROSS-REFERENCE TO RELATED APPLICATION

This application claims the priority of DE 10 2011 077 729.6 filed Jun. 17, 2011. The priority of this is hereby claimed and incorporated by reference herein.

### FIELD OF THE INVENTION

The invention relates to a seal arrangement, in particular cartridge seal, which has a carrier ring that is fastenable to a first bearing ring and a cover ring that is movable in relation to the carrier ring and fastenable to a second bearing ring. The carrier ring carries an elastic part which forms at least one sealing lip, and the sealing lip makes sliding sealing contact with the cover ring.

### BACKGROUND OF THE INVENTION

A cartridge seal for rolling bearings is known from DE 10 2008 063 597 A1 and is constructed from a carrier plate and a cover plate. The carrier plate carries an elastomer which also forms the two radial sealing lips. A second elastic part, which is reinforced by the carrier plate, surrounds the cover plate radially.

In particular, cartridge seals are used in rolling bearings, such as, for example, wheel bearings, but also in shafts because they provide a very good sealing action and very good handling, since cartridge seals can be pressed as a whole, axially in between the bearing rings of a rolling bearing and can also be stacked or transported in preinstalled form where the sealing lips are already in contact with the associated sealing surface, without the sealing lips being needlessly affected detrimentally or being soiled.

The disadvantage of seal arrangements of this type are that they are costly because an elastomer covering the cover ring radially signifies a second elastic part or the elastomer has to be applied to the carrier plate on both sides. Moreover, the carrier plate has to be led in a very materially intensive way around the annular space delimited by the carrier and the cover plate.

### SUMMARY OF THE INVENTION

The object of the invention is therefore to reduce the outlay in production terms and the material costs, while at the same time ensuring that the scaling action of the seal arrangement at least remains the same.

The object is achieved by a seal arrangement of the type mentioned in the introduction, in that the elastic part forms an overhang arranged axially on a radially running portion of the carrier ring, and the overhang radially covers a radial end piece of the cover ring at least partially or completely.

The seal arrangement according to the invention, in particular cartridge seal, has a carrier ring that is fastenable to a first bearing ring and a cover ring that is movable in relation to the carrier ring and fastenable to a second bearing ring. The first and the second bearing ring may be an outer ring or an inner ring of a rolling bearing, which is the respective ring forming a rolling body raceway. Alternatively, the ring may also be a wheel hub or another rotatable or static component of the rolling bearing on which one or more rolling body raceways are formed. Such a component with a rolling bearing raceway is understood to mean an aforesaid bearing ring.

The carrier ring is mostly produced from cold-formed sheet metal, but may also be composed of other materials, such as, for example, plastic. The carrier ring has the task of carrying the elastic part and of maintaining the prestress for sliding sealing contact with the cover disk.

The cover disk can be used as a centrifugal disk if it is fastened on a rotatable part or bearing ring. The fixed cover disk also has the function of sealing off the inner space of the rolling bearing outwardly, and the sealing action of a centrifugal disk benefits from its intrinsic rotation for the purpose of throwing off the splashwater. Otherwise, a fixed cover disk and a rotating cover disk can make sealing contact with a radial and/or axial sealing lip or else partially form a gap seal. The simplest form of a cover disk is composed of a cylindrical fastening part which merges at a bend into a radially running part and which covers the ring interspace axially. An L-shape is thus formed in longitudinal section along the axis of rotation.

The carrier ring carries an elastic part which forms at least one sealing lip. The sealing lip makes sliding sealing contact with the cover ring. The elastic part is composed, for example, of an elastomer or of another elastic material.

According to the invention, the elastic part forms an overhang arranged axially on a radially running portion of the carrier ring. The overhang radially covers a radial end piece of the cover ring at least partially. It is therefore not necessary that the carrier plate surrounds the radial part of the cover plate radially, but instead can be made shorter in its cylindrical fastening region. This leads to a material saving in that the overhang of the elastic part assumes the scaling function of the carrier plate as a preceding gap seal prior to the sealing contacts.

Advantageously, the overhang is designed to be thick in the radial direction such that the sealing gap formed with the cover plate does not vary during rolling bearing operation and therefore the sealing action is not influenced. In this case, the overhang may form an axially open annular space with the outer ring, which merges in the axial direction toward the fastening part of the carrier ring into a static seal between the carrier ring and outer ring, or the annular space ends abruptly or merges continuously into the static seal.

In one embodiment, the overhang covers a radially running sealing gap between the elastic part and the radial end piece and prevents the penetration of water and dirt. An intermediate piece of the elastic part adjoins the overhang radially on the inside, and forms the radially running sealing gap together with the radial part of the cover ring.

Since the radially running sealing gap is advantageously formed between the connection piece of the elastic part and the radial end piece of the radial part of the cover ring, the connection piece connects the overhang to the sealing lip and makes it possible, in spite of the plurality of functions of the elastic part, to use a single elastic part in order to implement the necessary sealing lips, for example radial and/or axial sealing lips, to partially produce the preceding, gap seal and to assume tasks of the carrier ring.

In another embodiment, both one end of a first fastening part of the carrier ring and one end of a second fastening part of the cover ring point to the rolling bearing interior. One end is in this case formed, far example, by the break edge of the cold-formed material used. Both the first and the second fastening part may be fastened to the respective rolling bearing ring by means of a press fit. Optionally, the elastic part forms a static seal at the connecting surfaces of the two parts.

Advantageously, the overhang is arranged at a bending point of the carrier ring at which the carrier ring is, for example, cold-formed. Consequently, despite the cover ring not being surrounded by the carrier ring, the seal arrangement becomes a cartridge seal. In this cartridge seal, the side facing the rolling bearing inner space is open, since the ends of both fastenable parts are directed toward the rolling bearing interior, and an annular space surrounded radially by the fastening parts forms, together with the rolling bearing interior, a space sealed off by the seal arrangement.

Advantageously, the overhang continues the first fastening piece in axial extension. Consequently, when the carrier ring and cover ring are in the operating position, the seal arrangement has advantageous stackability, in the axial direction, the overhang butting axially against the first fastening part of same of the seal arrangement of the adjacent cartridge seal or against its static seal.

Advantageously, the overhang also forms with the radial end piece an axially running sealing gap, the axially running sealing gap merging into the radially running sealing gap between the connection piece and radial end piece. Consequently, water or dirt particles must have a moment directed in the axial direction in order to pass at all into the axial sealing gap. However, where radial bearings are concerned, a mainly radially directed movement of dirt particles and water mostly occurs on the outside of the seal arrangement, and therefore effective shielding is also ensured, in a further embodiment, the cover ring is composed at least partially or completely of high-grade steel. Adverse corrosive seizure is consequently prevented. Alternatively, the cover ring is composed partially or completely of a surface-treated steel which cannot corrode on the outside on account of the surface treatment or where water cannot infiltrate under the surface. Corrosion protection layers of this type make it possible to use more cost-effective material and are applied, for example, together with zinc or chromium constituents contained in the corrosion protection layer.

Expediently, the cover ring composed at least partially or completely of high-grade steel or of a surface-treated steel does not necessarily have to be used with a seal arrangement according to the invention, in particular cartridge seal. A seal arrangement with a earner ring fastenable to a first bearing ring and a cover ring movable in relation to the carrier ring and fastenable to a second bearing ring may also be used. The carrier ring carrying an elastic part forms at least one sealing lip, and the sealing lip makes sliding sealing contact with the cover ring. In this case, too, a cost-effective seal arrangement can be produced, particularly when a corrosion protection layer is used.

As a result of the invention, the purchase price of rolling bearings, in particular wheel bearings or other rolling bearings, which can be used in spaces that are not closed off, for sealing off the rolling bearing inner space by the seal arrangements consequently falls.

Further advantageous refinements and developments of the invention will emerge from the FIGURE description.

### BRIEF DESCRIPTION OF THE DRAWING

The invention is described and explained in more detail below by the exemplary embodiment illustrated in the FIGURE in which:

The FIGURE shows an image, drawn in section in the longitudinal direction along the axis of rotation, of a seal arrangement in a radial bearing.

### DETAILED DESCRIPTION OF THE INVENTION

The FIGURE shows a seal arrangement, which is fastened by a press fit in an outer ring 10 and likewise by a press fit in an inner ring 11 to seal off a rolling bearing inner space that contains spherical rolling bodies 13.

A first fastening part 19 is protected against rust creeping underneath by a static seal 18 via an elastic part 16, for example an elastomer. Between the first fastening part 19 and an overhang 17, which leads further on axially, a carrier ring 22 merges from the cylindrical fastening part into a radially running portion 12 which, like the entire carrier ring 22, is covered axially on one side by the elastic part 16.

In this case, the elastic part 16 forms, at the radial carrier end 20, a radial sealing lip 24, which is in sliding sealing contact with a cylindrical second fastening part 21 of a cover ring 23.

Furthermore, the elastic part 16 forms an axial sealing lip 25, which is in sliding sealing contact with the radial part of the cover ring 23. The sealing lips 24, 25 thus form an annular space, which is formed together with the cover ring 23 and which, in the exemplary embodiment of the FIGURE, is filled with lubricant 27, such as, for example, grease or oil.

The elastic part 16 forms, via the annular space filled with the lubricant 27, a collecting channel 28 which receives dirt particles, but also, in particular, water, and diverts them circumferentially and conducts them out of the sealing gap forming the preseal.

The radial part of the sealing gap is formed between the radial end piece 14 of the radial part of the cover ring 23 and a connection piece 26 and merges at the overhang 17 into an axial part of the sealing gap. The axially running sealing, gap is formed by the radial end piece 14 and the overhang 17. The overhang 17 consequently radially surrounds the sealing gap and the cover ring 23 such that at least the radial part of the sealing gap has to be surrounded and covered radially. The cover part 23 may also be surrounded and covered partially by virtue of the axial thickness of the radial end piece 14.

Advantageously, the carrier ring 22 may be produced from metal or rubber. In this ease, rubber affords the necessary rigidity which prestresses the sealing lips 24, 25, in particular the axial sealing lip 25, with respect to the cover plate 23 in order to achieve the required seal pressure for respective sealing contact.

The covering ring is composed either of high-grade steel or of a surface-treated steel. The corrosion protection layer ideally contains chromium or zinc. These protection layers are sufficiently hard so as not to be damaged by sealing contact and also keep the remaining cover ring rust-free, in so far as each surface of the cover ring 17 is protected by a corrosion protection layer.

In summary, the invention relates to a seal arrangement, in particular a cartridge seal, with a carrier ring fastenable to a first bearing ring and with a cover ring movable in relation to the carrier ring and fastenable to a second bearing ring. The carrier ring carries an elastic part which forms at least one sealing lip, and the sealing lip makes sliding sealing contact with the cover ring. In order to specify a more cost-effective seal arrangement or cartridge seal, the elastic part forms an overhang arranged axially on a radially running portion of the carrier ring. The overhang radially covers a radial end piece of the cover ring at least partially. The elastic overhang consequently assumes the sealing function of the carrier ring so that the carrier ring forms a sealing gap with the cover ring. Material can consequently be saved on the carrier ring and on the elastic part because the elastic part has to be attached on only one axial side of the carrier ring and the fastening region of the carrier ring can be made smaller.

### LIST OF REFERENCE SYMBOLS

10 First Bearing Ring
11 Second Bearing Ring
12 Radially Running Portion
13 Rolling Body
14 Radial End Piece
15 Sealing Ring
16 Elastic Part
17 Overhang
18 Static Seal
19 First Fastening Part
20 Radial Carrier End
21 Second Fastening Part
22 Carrier Ring
23 Centrifugal Ring (Cover Ring)
24 Radial Sealing Lip
25 Axial Sealing Lip
26 Connection Piece
27 Lubricant
28 Collecting Channel

What is claimed:

1. A seal arrangement, comprising:
a carrier ring fastenable to a first bearing ring;
a cover ring, which is movable in relation to the carrier ring and fastenable to a second bearing ring, the cover ring having a radial end piece; and
an elastic part carried by the carrier ring and having at least one sealing lip in sliding sealing contact with the cover ring, the elastic part forming an overhang extending axially from the elastic part at a radially running portion of the carrier ring such that the overhang at least partially radially covers the radial end piece of the cover ring.

2. The seal arrangement according to claim 1, wherein the seal arrangement is a cartridge seal.

3. The seal arrangement according to claim 1, wherein the overhang covers a radially running sealing gap between the elastic part and the radial end piece.

4. The seal arrangement according to claim 3, wherein the elastic part has a connection piece, and the radially running sealing gap is formed between the connection piece and the radial end piece and connects the overhang to the sealing lip.

5. The seal arrangement according to claim 1, wherein the carrier ring has a first fastening part and the cover ring has a second fastening part, and both one end of the first fastening part of the carrier ring and one end of the second fastening part of the cover ring point to a rolling bearing interior.

6. The seal arrangement according to claim 1, wherein the overhang is arranged at a bending point of the carrier ring.

7. The seal arrangement according to claim 5, wherein the overhang acts as an axial extension of the first fastening piece.

8. The seal arrangement according to claim 4, wherein the overhang forms an axially running sealing gap with the radial end piece, and the axially running sealing gap merges into the radially running sealing gap between the connection piece and radial end piece.

9. The seal arrangement according to claim 1, wherein the cover ring is composed at least partially of high-grade steel or a surface-treated steel.

10. The seal arrangement according to claim 9, wherein the cover ring is composed completely of high-grade steel or a surface-treated steel.

11. A seal arrangement, comprising:
a carrier ring fastenable to a first bearing ring;
a cover ring movable in relation to the carrier ring and fastenable to a second bearing ring; and
an elastic part, which is carried by the carrier ring, having at least one sealing lip in sliding sealing contact with the cover ring,
wherein the cover ring is composed at least partially of high-grade steel or a surface-treated steel.

12. The seal arrangement according to claim 11, wherein the seal arrangement is a cartridge seal.

13. The seal arrangement according to claim 11, wherein the cover ring is composed completely of high-grade steel or a surface-treated steel.

14. A rolling bearing, comprising:
first bearing ring;
a second bearing ring; and
a seal arrangement for sealing off a rolling bearing inner space, the sealing arrangement including a carrier ring fastenable to the first bearing ring, a cover ring, which is movable in relation to the carrier ring and fastenable to the second bearing ring, the cover ring having a radial end piece, and an elastic part carried by the carrier ring and having at least one sealing lip in sliding sealing contact with the cover ring and an overhang extending axially from the elastic part at a radially running portion of the carrier ring such that the overhang at least partially radially covers the radial end piece of the cover ring.

15. The rolling bearing according to claim 14, wherein the rolling bearing is a wheel bearing.

16. The seal arrangement according to claim 14, wherein the cover ring is composed at least partially of high-grade steel or a surface-treated steel.

17. The seal arrangement according to claim 16, wherein the cover ring is composed completely of high-grade steel or a surface-treated steel.
